(19) United States
(12) Patent Application Publication
(10) Pub. No.: US 2007/0025531 A1
(43) Pub. Date: Feb. 1, 2007

(54) TELEPHONE WITH REPLACEABLE INCOMING-CALL ALERTS

(76) Inventor: Hung-Yen Lin, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,852

(22) Filed: Nov. 1, 2005

(30) Foreign Application Priority Data
Jul. 12, 2005 (TW) 094211817

(51) Int. Cl. H04M 11/00

(52) U.S. Cl. 379/93.37

(57) ABSTRACT

A telephone includes: an interface circuit for coupling an external line; a control circuit coupled to the interface circuit for controlling the operation of the telephone; a host device controller coupled to the control circuit, wherein the host device controller is utilized for coupling to an external storage device, and the control circuit controls the host device controller to read an audio file stored in the external storage device; an audio output device coupled to the host device controller for playing the audio file read by the host device controller; and a keypad coupled to the control circuit for dialing or inputting information into the control circuit.

### BACKGROUND OF THE INVENTION

1. Field of the Invention

The present invention relates to telephones, and more particularly, to a telephone with replaceable incoming-call alerts such as ringing tones, songs, or flashes.

2. Description of the Prior Art

Please refer to FIG. 1. FIG. 1 is a diagram of a telephone 10 according to the prior art. A main portion 10a of the telephone 10 comprises an interface circuit 11, a dialer 13, and a keypad 15, where the interface circuit 11 is coupled to an external line 60. In addition, a telephone transmitter 10b of the telephone 10 is coupled to the interface circuit 11, where through the telephone transmitter 10b, the interface circuit 11, the external line 60, etc., a user of the telephone 10 may have a conversation with another person. The dialer 13 is capable of performing basic telephone functions such as dialing through the interface circuit 11 according to information inputted from the keypad 15.

On the market, a typical telephone may utilize a speaker or a buzzer thereof to output ringing tones according to a signal having a specific frequency, where the signal mentioned above is typically generated by an internal circuit of the typical telephone. Conversely, an advanced telephone may utilize a speaker to output fixed-content polyphonic tones as ringing tones (e.g., multi-chord polyphonic ringing tones) according to a fixed-content audio source signal, which is typically generated by an internal circuit of the advanced telephone. As mentioned, the ringing tones outputted by either the typical telephone or the advanced telephone mentioned above will eventually become boring for the user since the content of the ringing tones of these telephones cannot be altered.

### SUMMARY OF THE INVENTION

It is an objective of the claimed invention to provide a telephone with replaceable incoming-call alerts.

According to one embodiment of the claimed invention, a telephone comprises: an interface circuit for coupling an external line; a control circuit coupled to the interface circuit for controlling the operation of the telephone; a host device controller coupled to the control circuit, wherein the host device controller is utilized for coupling to an external storage device, and the control circuit controls the host device controller to read an audio file stored in the external storage device; an audio output device coupled to the host device controller for playing the audio file read by the host device controller; and a keypad coupled to the control circuit for dialing or inputting information into the control circuit.

According to one embodiment of the claimed invention, the external storage device can be a storage device including Universal Serial Bus (USB) communication functionality, and the host device controller is a USB host device controller accordingly.

According to another embodiment of the claimed invention, the external storage device can be a memory card, and the host device controller is a memory card host device controller accordingly.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a telephone according to the prior art.

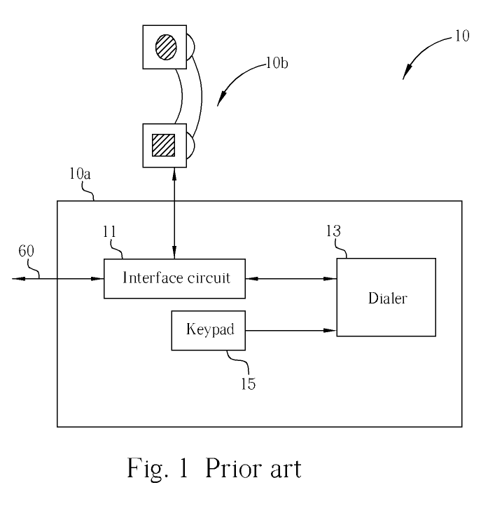

FIG. 2 is a diagram of a telephone according to a first embodiment of the present invention.

FIG. 3 is a diagram of a telephone according to a second embodiment of the present invention.

FIG. 4 is a diagram of a telephone according to a third embodiment of the present invention.

### DETAILED DESCRIPTION

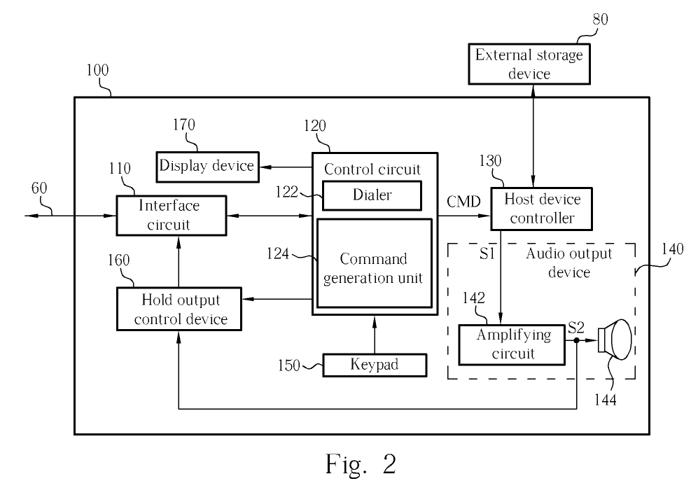

Please refer to FIG. 2. FIG. 2 is a diagram of a telephone 100 according to a first embodiment of the present invention. The telephone 100 comprises an interface circuit 110, a control circuit 120, a host device controller 130, an audio output device 140, a keypad 150, a hold output control device 160, and a display device 170, where the control circuit 120 comprises a dialer 122 and a command generation unit 124, and the audio output device 140 comprises an amplifying circuit 142 and a speaker 144. The host device controller 130 can be coupled to an external storage device 80, where the external storage device 80 can be a storage device complying with Universal Serial Bus (USB) transmission specifications, and the host device controller 130 is a USB host device controller accordingly. In addition, the display device 170 of this embodiment is a Liquid Crystal Display (LCD) module.

The interface circuit 1110 is utilized for coupling to an external line 60 and receiving caller ID transmitted through the external line 60. The telephone transmitter (not shown) of the telephone 100 is coupled to the interface circuit 110, where through the telephone transmitter mentioned above, the interface circuit 110, the external line 60, etc., a user of the telephone 100 may have a conversation with another person. The control circuit 120 controls the operation of the telephone 100, where the dialer 122 is capable of performing dialing control, and the command generation unit 124 is capable of generating a command CMD according to the caller ID such as a caller's telephone number correspondingly and requesting the host device controller 130 to read a corresponding audio file (i.e., an audio file corresponding to the caller ID) in the external storage device 80. The read audio file is decoded to generate an audio signal S1, which is sent to the audio output device 140 for further playing. In the audio output device 140 of this embodiment, the amplifying circuit 142 is utilized for amplifying the audio signal S1 to generate an amplified audio signal S2, and the speaker 144 plays the amplified audio signal S2.

Audio files in the external storage device 80 can be derived through various channels. For example, the user may retrieve many audio files by utilizing a computer system coupled to the Internet, or record audio files as needed by utilizing a microphone coupled to the computer system. The user may also utilize the computer system to execute specific application programs for generating various audio files. According to the embodiment mentioned above, by coupling the external storage device 80 to the computer system that includes USB ports, the audio files can be derived through various channels and saved in the external storage device 80, and the telephone 100 may utilize the audio files to generate its ringing tones.

The keypad 150 of this embodiment can be utilized for dialing or inputting information into the control circuit 120. The user may utilize the keypad to set the relationship between the callers and the audio file in advance according to individual preference or need. That is, the telephone 100 according to the present invention is capable of playing ringing tones corresponding to various callers, respectively. If the user has not performed the setting relationship mentioned above, the control circuit 120 is capable of selecting an audio file as the ringing tones according to a predetermined rule. For example, the control circuit 120 may select randomly; in another example, the control circuit 120 may select the first available audio file in the external storage device 80. On the other hand, the control circuit 120 may trigger the host device controller 130 according to the information inputted from the keypad 150 to read the audio files from the external storage device 80.

The host device controller 130 of this embodiment may further decode an audio file (e.g., an audio file representing an audio message or music) read from the external storage device 80 to generate the audio signal S1 as a hold output, where the audio file for generating the hold output is also referred to as the hold output file. According to control of the control circuit 120, the hold output control device 160 plays the amplified audio signal S2 (which is amplified from the audio signal S1) at the external line 60 through the interface circuit 110. The user may set one of the audio files in the external storage device 80 to be the hold output file in advance by utilizing the keypad 150. In addition, the user may also utilize the keypad 150 to set the hold output file corresponding to a specific caller. That is, the various callers may hear different hold outputs, respectively. If the user has not performed the hold output setting mentioned above, the control circuit 120 may select an audio file as the hold output file according to a predetermined rule. For example, the control circuit 120 may select the first available audio file in the external storage device 80; in another example, the control circuit 120 may select an audio file that the user recently played by utilizing the playback functionality of the telephone 100.

In a variation of the first embodiment, the hold output control device and the amplifying circuit are both coupled to the host device controller to receive the audio signal outputted by the host device controller. The hold output control device is capable of playing the audio signal outputted by the host device controller at the external line through the interface circuit. Similar descriptions for this variation are not repeated here.

In another variation of the first embodiment, the external storage device is a memory card, and the host device controller is a memory card host device controller, where the host device controller is capable of accessing the memory card (i.e., reading/writing data in the memory card) through an interface. Some computer systems on the market have card readers therein. Regarding those computer systems without any card reader, an external card read can be coupled to one of those computer systems to access the memory card. As a result, the user may derive various audio files as the ringing tones for the telephone of this variation. Similar descriptions for this variation are not repeated here. In different embodiments of the present invention, the external storage device can be any portable storage device including a USB connector, e.g., a storage device whose storage medium is a FLASH memory or a microdrive. By utilizing a communication port such as a USB port, the host device controller is capable of accessing the external storage device.

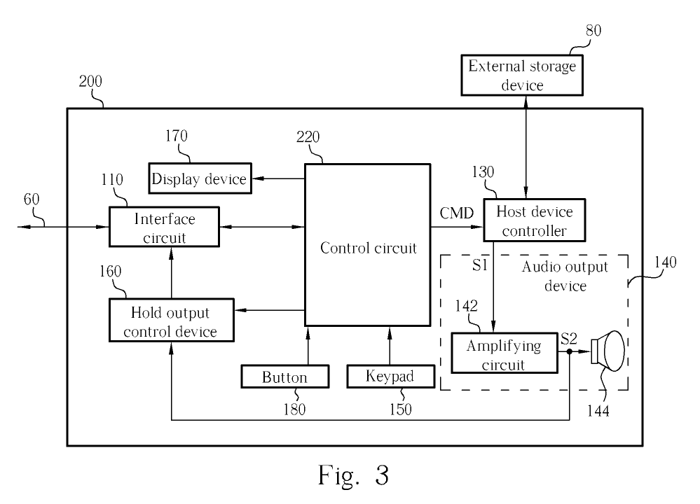

Please refer to FIG. 3. FIG. 3 is a diagram of a telephone 200 according to a second embodiment of the present invention. The second embodiment is similar to the first embodiment, where the differences between the two embodiments are described as follows. A control circuit 220 of the telephone 200 is a microcontroller for implementing the functionality of the control circuit 120. In addition, the telephone 200 comprises at least one button 180 coupled to the host device controller 130 through the control circuit 220, where the button 180 is capable of being utilized for triggering the host device controller 130 to read an audio file from the external storage device 80, in order to play the audio file. In a variation of this embodiment, the telephone comprises a plurality of buttons, where the user may utilize the buttons to select an audio file and trigger the host device controller to read the audio file (which is selected by the user) from the external storage device for further playing. In another variation of this embodiment, the at least one button mentioned above can be directly coupled to the host device controller.

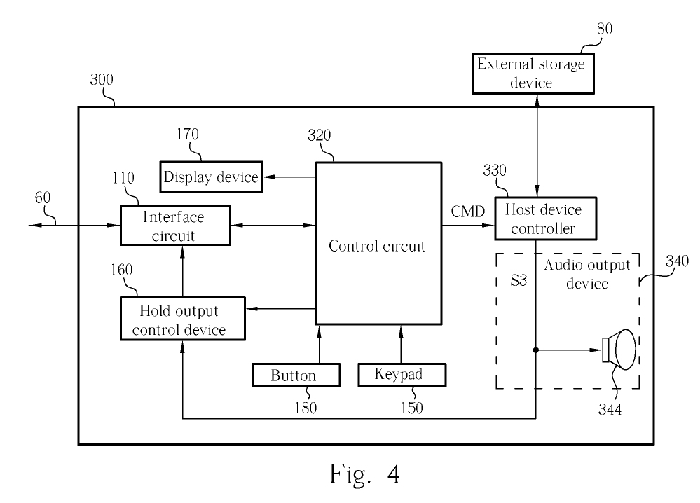

Please refer to FIG. 4. FIG. 4 is a diagram of a telephone 300 according to a third embodiment of the present invention. The third embodiment is similar to the second embodiment, where the differences between the two embodiments are described as follows. An audio output device 340 of the telephone 300 comprises a speaker 344, and the speaker 344 and the hold output control device 160 are both coupled to a host device controller 330 to receive an audio signal S3 outputted by the host device controller 330. The hold output control device 160 is capable of playing the audio signal S3 outputted by the host device controller 330 at the external line 60 through the interface circuit 110. Similar descriptions for this embodiment are not repeated here.

In contrast to the prior art, the user may replace the audio files stored in the external storage device, thereby allowing the ringing tones and the hold output of the telephone of the present invention to be replaced.

It is another advantage of the present invention that when the telephone of the present invention is damaged, the user may couple the external storage device to another telephone of the present invention, so the audio files originally stored in the external storage device can be utilized at once.

It is another advantage of the present invention that the telephone of the present invention can be a player for playing the audio files stored in the external storage device.

According to the present invention, integrating the control circuit and the host device controller mentioned above into one module in the telephone of the present invention is practical. In various embodiments, a memory can be further installed and coupled to the host device controller, where the memory is utilized for storing the data that the host device controller reads from the external storage device. Additionally, after the data in the external storage device is stored in the memory, the external storage device can be detached from the telephone of the present invention. According to this architecture, when the telephone receives a phone-call, the control circuit controls the host device controller to read the audio file(s) from the memory as needed, in order to play by utilizing the audio output device. Those skilled in USB technologies will appreciate that in other embodiments of the present invention, a controller complying with USB OTG specifications can be utilized for implementing the host device controller of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A telephone comprising:
an interface circuit for coupling an external line;
a control circuit coupled to the interface circuit for controlling the operation of the telephone;
a host device controller coupled to the control circuit, wherein the host device controller is utilized for coupling to an external storage device, and the control circuit controls the host device controller to read an audio file stored in the external storage device;
an audio output device coupled to the host device controller for playing the audio file read by the host device controller; and
a keypad coupled to the control circuit for dialing or inputting information into the control circuit.

2. The telephone of claim 1, wherein the control circuit comprises:
a dialer for dialing control; and
a command generation unit capable of generating a command according to caller ID to play the audio file corresponding to the caller ID.

3. The telephone of claim 1, wherein the control circuit is a microcontroller.

4. The telephone of claim 1, wherein the external storage device is a storage device including Universal Serial Bus (USB) communication functionality, and the host device controller is a USB host device controller.

5. The telephone of claim 1, wherein the external storage device is a memory card, and the host device controller is a memory card host device controller.

6. The telephone of claim 1, wherein the host device controller is capable of decoding the audio file to generate an audio signal.

7. The telephone of claim 6, wherein the audio output device comprises:
an amplifying circuit for amplifying the audio signal; and
a speaker coupled to the amplifying circuit for playing the audio file according to the amplified audio signal.

8. The telephone of claim 6, wherein the audio output device comprises:
a speaker for playing the audio file according to the audio signal.

9. The telephone of claim 1, wherein the host device controller is capable of decoding a hold output file read from the external storage device to generate an audio signal.

10. The telephone of claim 9, further comprising:
a hold output control device coupled to the interface circuit, the control circuit, and the host device controller for playing the audio signal at the external line through the interface circuit according to control of the control circuit.

11. The telephone of claim 9, wherein the audio output device comprises an amplifying circuit for amplifying the audio signal, and the telephone further comprises:
a hold output control device coupled to the interface circuit, the control circuit, and the amplifying circuit for playing the amplified audio signal at the external line through the interface circuit according to control of the control circuit.

12. The telephone of claim 9, wherein the hold output file is corresponding to caller ID.

13. The telephone of claim 12, wherein the keypad is capable of being utilized for setting the hold output file corresponding to the caller ID.

14. The telephone of claim 9, wherein the hold output file is the audio file or another audio file.

15. The telephone of claim 1, wherein the control circuit is capable of triggering the host device controller according to the information inputted into the control circuit from the keypad to read the audio file or another audio file from the external storage device, and the audio output device is capable of playing the read audio file.

16. The telephone of claim 1, further comprising:
at least one button coupled to the control circuit or the host device controller for triggering the host device controller to read the audio file or another audio file from the external storage device;
wherein the audio output device is capable of playing the read audio file.

17. The telephone of claim 1, wherein the keypad is capable of being utilized for setting the audio file corresponding to caller ID.

18. The telephone of claim 1, further comprising:
a display device coupled to the control circuit for displaying caller ID.

19. The telephone of claim 1, further comprising:
a memory connected to the host device controller, the memory being utilized for storing data read by the host device controller from the external storage device.
